(19) United States
(12) Patent Application Publication
(10) Pub. No.: US 2010/0201950 A1
(43) Pub. Date: Aug. 12, 2010

(54) IN-CABIN ROOM PROJECTION FOR AIRCRAFT

(75) Inventors: Tilo Budinger, Hamburg (DE); Guenter Schmitz, Jesteburg (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: AIRBUS OPERATIONS GMBH, Hamburg (DE)

(21) Appl. No.: 12/701,913

(22) Filed: Feb. 8, 2010

Related U.S. Application Data
(60) Provisional application No. 61/207,382, filed on Feb. 11, 2009.

(30) Foreign Application Priority Data
Feb. 11, 2009 (DE) 10 2009 008 543.2

(51) Int. Cl. G03B 21/58

(52) U.S. Cl. 353/13; 359/461

(57) ABSTRACT

The invention pertains to the projection of image contents in an aircraft. A mechanical projection surface is provided that features a gear with two thrust sleeves and two gear rods. The two thrust sleeves are displaced opposite to one another due to the rotation of a threaded rod. Each of the two thrust sleeves carries along an assigned gear rod such that a projection screen is respectively retracted or extended.

### CROSS-REFERENCE TO RELATED APPLICATIONS

This application claims the benefit of the filing date of U.S. Provisional Patent Application No. 61/207,382 filed Feb. 11, 2009, the disclosure of which application is hereby incorporated herein by reference.

### BACKGROUND OF THE INVENTION

The invention pertains to the in-cabin room projection in aircraft. The invention particularly pertains to a mechanical projection surface for a projection system for an aircraft, a projection system with a mechanical projection surface, an aircraft, a method for extending a mechanical projection surface of a projection system, as well as a method for retracting the projection surface.

In commercial aircraft and, in particular, in long-range aircraft, it is desirable to design the cabin in such a way that the stay on board the aircraft is as pleasant as possible for the passengers. Projectors may be used for this purpose in order to provide the passengers, for example, with optical information.

DE 102 15 893 C1 discloses a projection device and a projection method, in which images are projected onto surfaces such as a headrest, a backrest, a door panel or a ceiling panel, wherein a distortion correction of the displayed image can be realized if the image is projected onto a concavely or convexly curved surface or angularly onto a plane surface.

DE 10 2007 027 420 B3 and WO 2008/151977 disclose a projection method and a projection device for projecting an overall image onto inner walls of an aircraft, wherein a large-surface and undistorted image representation is achieved despite curved projection surfaces and angular projection.

The above-described projection systems feature an arithmetic unit (processor unit) that includes the curvatures of the projection surfaces and the angular projection into its calculations when the image to be projected is generated.

Display systems on the basis of the TFT technology are also known. The displays are luminous, but may be comparatively heavy and may require a large installation space.

### BRIEF SUMMARY OF THE INVENTION

Disclosed are a mechanical projection surface for a projection system for an aircraft, a projection system with a mechanical projection surface and a projector, an aircraft with an interior furnishing and a projection system, a method for extending the mechanical projection surface of a projection system in an aircraft and a method for retracting the projection surface according to the characteristics of the independent claims. Additional developments of the invention result from the dependent claims.

According to one exemplary embodiment of the invention, a mechanical projection surface for a projection system for an aircraft is disclosed, wherein said projection surface features a mechanical gear and a projection screen. The gear features a first and a second thrust sleeve, as well as a first and a second gear rod, by means of which the projection screen can be transferred from a retracted (for example rolled up) state into an extended (for example unrolled) state. In this case, the first gear rod is connected to the first thrust sleeve and the second gear rod is connected to the second thrust sleeve.

When the mechanical gear is actuated, the two thrust sleeves are displaced and carry along the corresponding regions of the two gear rods such that the projection screen is either retracted or extended depending on the moving direction of the gear.

This is a retractable projection surface that occupies minimal structural space in the retracted state. In addition, the projection surface has a very simple mechanism that has a low susceptibility to defects and a low weight. The mechanical projection surface is very reliable with respect to its operation and normally does not have to be serviced.

For example, the first and the second gear rods comprise a common crossing region at which region both gear rods cross each other, wherein a position of the crossing region moves with respect to both gear rods when at least the first thrust sleeve moves.

This may provide for simplified projection of image data in an aircraft that requires a comparatively small installation space.

According to another exemplary embodiment of the invention, the gear furthermore features a threaded rod that is designed for displacing the first and the second thrust sleeve in opposite directions.

It is also possible to provide two separate threaded rods that are respectively driven by their own drive.

According to another exemplary embodiment of the invention, the projection surface furthermore features an electric motor for driving the threaded rod. If several threaded rods are provided, it is also possible to provide several electric motors that are synchronized with one another, for example, by means of corresponding electronics.

The electric motor is wired to a data bus (e.g., a CAN-Bus) and connected to a control unit via this bus such that the passenger can operate the projection surface. It may also be possible that the projection surface extends automatically when the corresponding projector is switched on. In this case, the projection surface automatically retracts when the corresponding projector is switched off.

According to another exemplary embodiment of the invention, the projection surface furthermore features a sleeve that guides the first gear rod and the second gear rod. The two gear rods intersect and the sleeve is arranged in the region of the intersection, wherein said sleeve serves for guiding the first and the second gear rod in an intersecting fashion when the first thrust sleeve and the second thrust sleeve are moved.

The stability of the projection surface may be ensured in this fashion.

According to another exemplary embodiment of the invention, the projection surface features a rolling device for accommodating the projection screen. This means that the projection screen can be rolled up when it is not in use.

According to another exemplary embodiment of the invention, the rolling device features a spring device that is designed for facilitating the process of rolling up the projection screen on the roll. The spring device is correspondingly prestressed when the projection screen is unrolled.

According to another exemplary embodiment of the invention, a projection system for an aircraft is disclosed that features a mechanical projection surface of the type described above and below, as well as a projector. As already mentioned above, the mechanical projection surface features a mechanical gear and a projection screen. The gear features, among other things, two thrust sleeves and two gear rods. The projector is designed for projecting optical information onto a projection surface.

The projector consists, for example, of a very compact LED projector that has the size of a matchbox and a weight of approximately 50 g, wherein this projector is also highly energy efficient (power consumption approximately 3-5 Watt). The projector therefore can be easily installed into a control panel that is arranged, for example, above the passenger seat (so-called Passenger Service Unit, PSU).

Due to the inventive unrolling and rolling-up method, the mechanical projection surface is also very light and compact and therefore suitable for the invisible integration into the passenger service channel.

At this point, it should be noted that the aircraft may be a passenger aircraft. However, it may also may be a helicopter or an airship. The projection system can be installed into other means of transport as well, for example into rail vehicles, watercraft or road vehicles such as buses, railway cars or ships, e.g. ferries.

According to another exemplary embodiment of the invention, an aircraft is disclosed that features an interior furnishing, as well as a projection system with a mechanical projection surface of the type described above and below and a projector. The projection surface and the projector are arranged on the interior furnishing.

According to another exemplary embodiment of the invention, the projection surface is completely integrated into the interior furnishing, i.e. largely invisible, in the retracted state. In addition, the projector is also completely integrated into the interior furnishing.

For example, the projector is covered with a transparent glass pane that ends flush with the surface of the interior furnishing. The lens of the projector naturally may also protrude out of the interior furnishing.

According to another exemplary embodiment of the invention, the interior furnishing consists of a cover panel for a Passenger Service Unit.

The projector and the projection surface therefore are integrated into the passenger service channel.

According to another exemplary embodiment of the invention, a method for extending a mechanical projection surface of a projection system in an airplane is disclosed, wherein a threaded rod is rotated by an electric motor. The rotation of the threaded rod causes a displacement of a first thrust sleeve and a second thrust sleeve in opposite directions. When the two thrust sleeves are displaced in opposite directions, a first gear rod and a second gear rod are guided in an intersecting fashion. The movement of the two gear rods causes a screen of the projection surface to be pulled out from an interior furnishing of the aircraft and, if applicable, to be unrolled from a corresponding roll. A spring in the roll is tensioned during this process due to the rotation.

The retraction of the mechanical projection surface of the projection system takes place accordingly. In this case, the electric motor rotates the threaded rod in a different direction than during the extension such that the two thrust sleeves are also displaced in opposite directions, however, opposite to the direction during the extending process.

The two gear rods are also guided in an intersecting fashion in this case. This causes the projection screen to be retracted into the interior furnishing and, if applicable, to be rolled up. The roll is driven by the spring that was tensioned during the unrolling process and now relaxes.

At this point, it should be noted that the characteristics of the projection surface described above and below also apply to the projection system, the aircraft and the methods. This means that, for example, the characteristics described below with respect to the projection surface can and should also be implemented as procedural steps.

Exemplary embodiments of the invention are described below with reference to the figures.

### BRIEF DESCRIPTION OF THE DRAWINGS

FIG. 1 shows a detail of a passenger cabin of an aircraft with a projection system according to one exemplary embodiment of the invention.

FIG. 2 shows cross-sectional representations of a projection surface according to one exemplary embodiment of the invention in the closed and in the open state.

FIG. 3 shows an aircraft according to one exemplary embodiment of the invention.

FIG. 4 shows a flow chart of a method according to one exemplary embodiment of the invention.

### DETAILED DESCRIPTION

The figures show schematic illustrations that are not true-to-scale. In the following description of the figures, the same reference symbols are used for identical or similar elements.

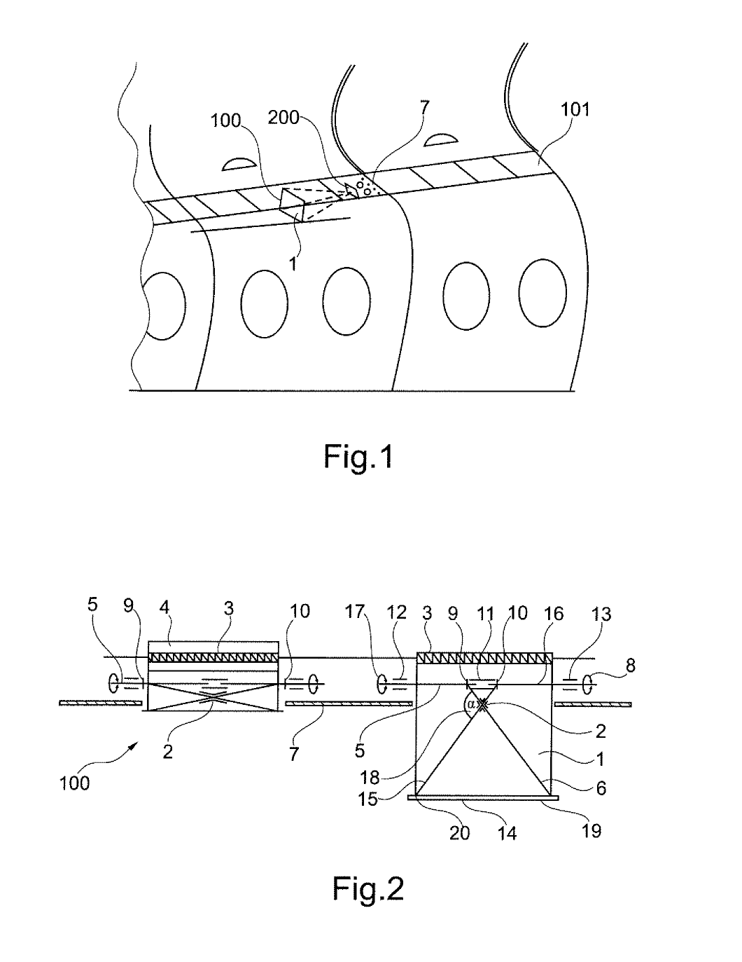

FIG. 1 shows a detail of an aircraft cabin with a passenger service channel 101, into which several PSUs 7 are integrated. In addition to lighting and control elements, each of the PSUs 7 features an integrated projector 200, as well as an integrated mechanical projection surface 100 with a projection screen 1.

It is naturally also possible to integrate the projector into a first interior furnishing element (for example a first PSU, a wall element or a ceiling element) and to integrate the projection surface 100 into a second interior furnishing element (for example a second PSU or a cover panel for the passenger service channel 101 or another wall element or ceiling element).

The projection surface 100 is realized in the form of a compact, fully automated projection screen that is integrated into the channel.

The projector 200 comprises, for example, one or more miniaturized LED projectors or so-called pico LED projectors. The projection screen 1 serves as imaging surface for the image projected by the pico LED projector 200. The pica LED projector 200 is integrated into the PSU 101 in a concealed fashion. The projection surface used consists of a mechanically retractable and extendable projection surface 100 that is invisible to the passengers when the projection system is not in use. Due to the very compact construction of both the projector 200 and the projection surface 100, it is possible to integrate the system into the passenger service channel 101 without affecting the emergency oxygen supply and without restricting its function.

Due to the simple and compact construction of the projection system, a significant weight reduction is achieved in comparison with conventional systems and the installation volume is reduced. Furthermore, only comparatively little energy is required for operating the projector, as well as the projection surface.

In the retracted state, the projection screen is invisible or concealed as long as it remains rolled up. Consequently, there is no risk of a passenger bumping his head against the projection screen and the headroom while standing and sitting is not restricted further.

FIG. 2 shows two sectional representations of a mechanical projection surface 100 in the retracted state (left illustration) and in the extended state (right illustration).

The mechanical projection surface 100 features a projection screen 1 that is rolled up on the rolling device 4 during the retraction (see lift illustration).

The rolling device 4 features a spring device 3 that is prestressed when the screen 1 is unrolled in order to facilitate the subsequent rolling-up process. This means that no extra drive is required for the rolling device 4.

In addition, a mechanical gear is provided that features two thrust sleeves 9, 10 and two gear rods 6, 15. A threaded rod 5 is furthermore provided and driven by an electric motor (that is not illustrated in FIG. 2). Two thrust sleeves 9, 10 are situated on the threaded rod 5. The left section of the threaded rod 5 features, for example, a left-handed thread and the right region of the threaded rod 5 features a right-handed thread (or vice versa). Due to these measures, the two thrust sleeves 9, 10 are displaced along the threaded rod 5 in opposite directions when the threaded rod is rotated.

It may also be possible to provide two threaded rods 5, 16 that are respectively driven by their own electric motor. The threaded rods are supported in the region of the interfaces 17, 8 with the electric motors by means of the outer bearings 12, 13. Another bearing 11 is provided in the center of the projection surface and supports the two ends of the gear rods 5, 16 that face one another.

In addition, a floating sleeve 2 is provided that guides the intersecting gear rods 6, 15 at the intersecting point. In this case, the floating sleeve 2 features articulations such that it can assume the intersecting angle alpha (see reference symbol 18) between the two gear rods 6, 15.

The projection system 100, 200 therefore essentially consists of two modules, namely the pico LED projection unit 200 and the projection surface with the projection screen 100 that can be unrolled and rolled up.

The unrolling of the projection screen is realized with an electrically driven mechanical gear that operates against the resistance of a spring 3 arranged in the interior of the roll 4. The spring 3 is tensioned during the unrolling process and ensures that the projection screen 1 is rolled up when the gear is reversed. In the unrolled state, the projection screen 1 is inclined in such a way that the viewing direction of the passenger extends perpendicular to the projection screen.

The thrust sleeves 9, 10 are mounted on the threaded rods 5, 16 and move the gear rods 6, 15 to the left and to the right on the upper ends when the threaded rods 5, 16 are driven. Since the gear rods 6, 15 are connected to the projection screen 1 on the lower ends 19, 20 and the gear rods are connected to one another by means of the floating sleeve 2, the projection screen 1 is respectively pushed downward or pulled upward when the screen is unrolled and rolled up.

The spring 3 situated in the roll 4 for accommodating the projection screen 1 is tensioned during the unrolling of the projection screen 1. During the rolling-up of the projection screen 1, the tensioned spring 3 facilitates the return movement and guarantees that the projection screen 1 is exactly rolled up on the roll 4.

In order to prevent the projection screen from collapsing, a cross brace 14 is provided between the lower points of motion 19, 20 of the gear rods 6, 15 and fixed on the screen 1.

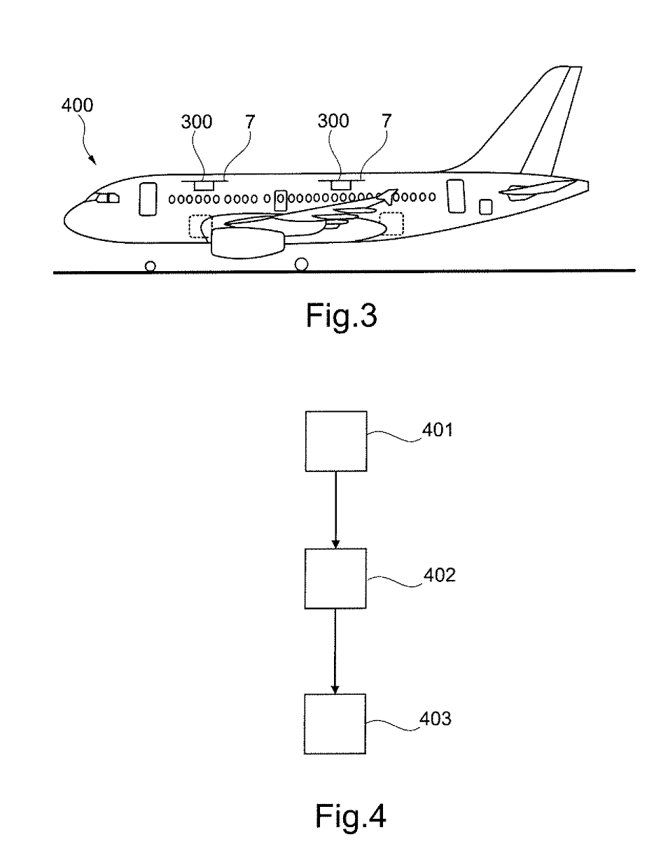

FIG. 3 shows an aircraft 400 with several of the above-described projection systems 300, as well as corresponding interior furnishings 7.

FIG. 4 shows a flow chart of a method according to one exemplary embodiment of the invention, in which the threaded rod or threaded rods 15, 16 of a projection surface are rotated in step 401. The drive of the threaded rods is respectively realized in the form of one or two electric motors. Two thrust sleeves are displaced in opposite directions due to the rotation of the threaded rods (see step 402). The upper ends of two gear rods are fixed on the thrust sleeves such that the gear rods are displaced and guided in step 403, wherein the gear rods intersect at a shifting yet defined point and thusly ensure that the screen is respectively rolled up and unrolled.

As a supplement, it should be noted that “comprising” and “featuring” do not exclude other elements or steps, and that “an” or “a” does not exclude a plurality. It should furthermore be noted that characteristics or steps that were described with reference to one of the above exemplary embodiments can also be used in combination with other characteristics or steps of other above-described exemplary embodiments. Reference symbols in the claims should not be interpreted in a restrictive sense.

1. A mechanical projection surface for a projection system for an aircraft, with said projection surface comprising:
a mechanical gear; and
a projection screen;
wherein the gear comprises a first thrust sleeve, a second thrust sleeve, a first gear rod and a second gear rod, by means of which a projection screen can be transferred from a retracted state into an extended state; and
wherein the first gear rod is connected to the first thrust sleeve and the second gear rod is connected to the second thrust sleeve; and
wherein the first and second gear rods comprise a common crossing region at which region both gear rods cross each other, wherein a position of the crossing region moves with respect to both gear rods when at least the first thrust sleeve moves.

2. The projection surface of claim 1,
wherein the gear further comprises a threaded rod that is designed for displacing the first and second thrust sleeves in opposite directions.

3. The projection surface of claim 2, further comprising: an electric motor for driving the threaded rod.

4. The projection surface of claim 1, further comprising: a sleeve for guiding the first and the second gear rods in an intersecting fashion when the first thrust sleeve and the second thrust sleeve are moved.

5. The projection surface of claim 1, further comprising: a rolling device for accommodating the projection screen.

6. The projection surface of claim 5,
wherein the rolling device comprises a spring device;
wherein the spring device is designed for facilitating the process of rolling up the projection screen on a roll.

7. A projection system for an aircraft, with said projection system comprising:
a mechanical projection surface; and
a projector;
wherein the projection surface comprises a mechanical gear and a projection screen;
wherein the gear includes a first thrust sleeve, a second thrust sleeve, a first gear rod and a second gear rod, by means of which a projection screen can be transferred from a retracted state into an extended state;
wherein the first gear rod is connected to the first thrust sleeve and the second gear rod is connected to the second thrust sleeve;
wherein the projector is designed for projecting optical information onto the projection surface;
wherein the first and second gear rods comprise a common crossing region at which region both gear rods cross each other, wherein a position of the crossing region moves with respect to both gear rods when at least the first thrust sleeve moves.

8. The projection system of claim 7, wherein the gear further comprises a threaded rod that is designed for displacing the first and second thrust sleeves in opposite directions.

9. An aircraft comprising:
an interior furnishing; and
a projection system with a mechanical projection surface and a projector;
wherein the projection surface includes a mechanical gear and a projection screen;
wherein the gear includes a first thrust sleeve, a second thrust sleeve, a first gear rod and a second gear rod, by means of which a projection screen can be transferred from a retracted state into an extended state;
wherein the first gear rod is connected to the first thrust sleeve and the second gear rod is connected to the second thrust sleeve;
wherein the projector is designed for projecting optical information onto the projection surface;
wherein the projection surface and the projector are arranged on the interior furnishing; and
wherein the first and second gear rods comprise a common crossing region at which region both gear rods cross each other, wherein a position of the crossing region moves with respect to both gear rods when at least the first thrust sleeve moves.

10. The aircraft of claim 9, wherein the gear further comprises a threaded rod that is designed for displacing the first and second thrust sleeves in opposite directions.

11. The aircraft of claim 9, wherein the projection surface is completely integrated into the interior furnishing in the retracted state; and wherein the projector is completely integrated into the interior furnishing.

12. The aircraft of claim 9, wherein the interior furnishing includes a cover panel for a Passenger Service Unit (PSU).

13. A method for extending a mechanical projection surface of a projection system in an aircraft, with said method comprising:
rotating a first threaded rod in a first direction by means of an electric motor;
displacing first and second thrust sleeves in opposite directions due to the rotation of the first threaded rod; and
guiding the first threaded rod and a second threaded rod in an intersecting fashion when the first thrust sleeve and the second thrust sleeve are displaced in opposite directions;
wherein first and second gear rods comprise a common crossing region at which region both gear rods cross each other, wherein a position of the crossing region moves with respect to both gear rods when at least the first thrust sleeve moves.

14. A method for retracting a mechanical projection surface of a projection system in an aircraft, with said method comprising:
rotating a first threaded rod in a second direction by means of an electric motor;
displacing first and second thrust sleeves in opposite directions due to the rotation of the first threaded rod; and
guiding the first threaded rod and a second threaded rod in an intersecting fashion when the first thrust sleeve and the second thrust sleeve are displaced in opposite directions;
wherein first and second gear rods comprise a common crossing region at which region both gear rods cross each other, wherein a position of the crossing region moves with respect to both gear rods when at least the first thrust sleeve moves.
